(19) United States
(12) Patent Application Publication
(10) Pub. No.: US 2018/0124453 A1
(43) Pub. Date: May 3, 2018

(54) DYNAMIC GRAPHIC VISUALIZER FOR APPLICATION METRICS

(71) Applicant: App Onboard, Inc., Los Angeles, CA (US)

(72) Inventors: Jonathan Lee Zweig, Los Angeles, CA (US); Adam Piechowicz, Santa Monica, CA (US)

(21) Appl. No.: 15/801,254

(22) Filed: Nov. 1, 2017

Related U.S. Application Data
(63) Continuation-in-part of application No. 15/614,425, filed on Jun. 5, 2017.
(60) Provisional application No. 62/415,674, filed on Nov. 1, 2016.
(60) Provisional application No. 62/415,674, filed on Nov. 1, 2016.

(51) Int. Cl. H04N 21/431; G06F 17/30; H04N 21/472; H04L 29/08

(52) U.S. Cl. CPC H04N 21/4312; G06F 17/30554; G06F 11/3438; H04L 67/06; H04N 21/47217

(57) ABSTRACT

The disclosed invention provides a novel approach to analyzing user-interaction data of digital applications. The invention enables easy-to comprehend visualizations of user interactions with an application, wherein the data visualizations are played either as an overlay, or alongside a replay video of the application. Flexible visualization options allow for the overlay of intuitive images that display analytics of how the application is being used, such as correlating colors, shapes and images to high volume user interactions versus low volume user interactions. Furthermore, visualizations are displayed along a chronological continuum of the application. A variety of filters can be put on the data that is visualized, allowing the developer to see user engagement at specified segments of the application.

### CLAIM OF PRIORITY

This application claims the benefit of priority under 35 U.S.C. § 119(e) to U.S. provisional application Ser. No. 62/415,674, filed Nov. 1, 2016, and under 35 U.S.C. § 120 to U.S. patent application Ser. No. 15/614,425, filed Jun. 5, 2017, the entire disclosures of which are incorporated herein by reference.

### TECHNICAL FIELD

The current disclosure relates to data analytics, web analytics, and application analytics for online gaming, mobile gaming, mobile application products, consumer mobile applications, video and interactive web. Specifically, the disclosure relates to application development and serves the purpose of optimizing user retention, application improvements and application marketing.

### BACKGROUND

Today, with the growing complexity of computer and mobile device applications, developers and marketing organizations find it increasingly difficult to understand how users are interacting with a given product. While companies such as Google Analytics, Yahoo!'s Flurry, MixPanel, Kontagent, Unity and GameAlytics offer some application analytics capabilities, the methods currently available are only able to provide static graphical imagery. Generally, existing graphical analytics systems lack flexibility and accuracy if a user wants to, for example, display analytics in tandem with a video that is replaying the user application experience. As such, it is hard to understand at what phase of a user's experience with an application the user made a specific decision, such as continuing to engage with the application, or deciding to leave it.

Google Analytics offers, for example, a static graph of the number of users on a webpage at a certain time. It also allows an application owner to see how long an individual has remained on a page, as well as at what points of the user experience, users decide to leave a page. This method provides for a chart visualization across an x-y axis. These visualizations offer a basic understanding of user behavior, but lack the ability to granularly represent, such as using video replay, an aggregated view of user activity.

Application Stores also provide analytics on when application users leave an application. However, the application store cannot provide information as to the precise movements of users before or after they exit, therefore providing little insight as to why they are exiting the application. The Apple App Analytics Dashboard, for example, provides high level numerical figures representing the number of App Users, Sales, Sponsors, and App Store Views. It also provides a bar chart showing the progress of each of these categories over time, as well as a map of the globe with color symbols representing the geographic location of users. But such data offers no or very little insight into the detailed interactions between individual users and an application.

Third party analytics providers such as MixPanel (Internet web-site at mixpanel.com/engagement) and UpSight (Internet web-site at www.upsight.com) utilize an analytics dashboard with data analytics charts. The charts are flexible enough to provide straightforward ways to input data and to customize data table headers and categories. While third party analytics platforms generally provide more data visualization options than the application store analytics platforms, they remain unable to provide the analytics while also simultaneously providing accurate video-playback of an application in use.

In short, existing methods for application analytics center on bar graphs and charts. These methods do not provide insight as to why a user has exited an application because there is no method for visualizing the precise user interactions during their time spent on the application leading up to the moment of exiting. Given the difficulty of understanding why users make certain decisions in an application, developers are not able to obtain the insight required to improve the application to avoid or augment user decisions as desired.

A method that would allow developers to understand where a user hesitated or felt confused would allow the developer to improve the user experience in that segment. Similarly, a method for understanding immediate user response and a basis for continued engagement would suggest a positive application feature that should be maintained. Nevertheless, such a method is necessarily non-trivial to implement, due at least in part to the complexities of monitoring user-level interactions, the likely volume of data associated with user-level interactions, and the challenges of presenting the data in a manner that provides useful insights to an application developer.

### SUMMARY

A system and method for application analytics addresses a desire for application developers to understand how and to what extent users are interacting with an application. The system and method enable easy-to-comprehend visualizations of user interactions with an application, where the data visualizations are played either as an overlay, or alongside a replay video, of the application as it is being used. Flexible visualization options allow for the overlay of intuitive images that display analytics of how the application is being used, such as correlating colors, shapes and images to high volume user interactions versus low volume user interactions. Furthermore, visualizations are displayed along a chronological continuum of the application. A variety of filters can be put on the data that is visualized, allowing the developer to see user engagement at specified segments of the application.

The method is implemented as instructions on a computer readable medium for execution by a computer processor. A system that performs the method can be any suitably-programmed computing apparatus, whether mobile or desktop-situated.

### BRIEF DESCRIPTION OF THE DRAWINGS

FIG. 1 shows an exemplary process as described herein.

FIG. 2 shows a second aspect of an exemplary process as described herein.

FIG. 3 shows an aspect of a process for creating a video-tree, as further described herein.

FIG. 4 shows an aspect of a process for displaying playback, as further described herein.

FIG. 5 shows an exemplary program interface, having a heat map.

### DETAILED DESCRIPTION

The invention provides a precise, highly detailed recreation of any user experience. This allows the developer to visualize user behavior via a graphical, video-oriented display. The presentation allows for greater detail than existing industry analytics solutions. The presentation provides an immersion for the viewer, as if the viewer is watching many users live interact with the application. The experience is analogous with immersive learning techniques, where computer-based learning allows a learner to be totally immersed in a self-contained artificial or simulated environment.

The current disclosure provides for a dynamic application visualization system. The system provides front-end controls and an associated software backend allowing for the robust exploration of application user interactions. The front-end controls contain a variety of visualizations. The front-end interface allows the viewer to adjust the data feed which changes the information displayed in the graphic visualization.

### Terms

“Application store” and “App Store” refer to an online store for purchasing and downloading software applications and mobile apps for computers and mobile devices.

“Application” refers to software that allows a user to perform one or more specific tasks. Applications for desktop or laptop computers are sometimes called desktop applications, while those for mobile devices such as mobile phones and tablets are called apps or mobile apps. When a user opens an application, it runs inside the computer's operating system until the user closes it. Apps may be continually active, however, such as in the background while the device is switched on. The term application may be used herein generically, which is to say that—in context—it will be apparent that the term is being used to refer to both applications and apps.

“Streaming” refers to the process of delivering media content to a user, that is constantly received by and presented to an end-user while being delivered by a provider. A client end-user can use their media player to begin to play the data file (such as a digital file of a movie or song) before the entire file has been transmitted.

“Video Sampling” refers to the act of appropriating a portion of preexisting digital video and reusing it to recreate a new video.

“Feedback loop” refers to a process in which outputs of a system are routed back as inputs as part of a chain of cause-and-effect that forms a circuit or loop. The system can then be said to feed back into itself. In the context of application feature testing, the term feedback loop refers to the process of collecting end-user data as an input, analyzing that data, and making changes to the application to improve the overall user experience. The output is the set of improved user experience features.

“Native Application” refers to an application program that has been developed for use on a particular platform or device.

“Creative Concept Script” refers to the written embodiment of a creative concept. A creative concept is an overarching theme that captures audience interest, influences their emotional response and inspires them to take action. It is a unifying theme that can be used across all application messages, calls to action, communication channels and audiences.

“Computational Logic” refers to the use of logic to perform or reason about computation, or “logic programming.” A program written in a logic programming language is a set of sentences in logical form, expressing facts and rules within a specified domain.

“Application Content Branches” refer to the experiential content of a software application, organized into a branch-like taxonomy representative of the end-user experience.

“High Branching Factor” refers to the existence of a high volume of possible “Application Content Branches.” The branches contain a plurality of variances, each ordered within a defined hierarchical structure.

“Genetic Algorithm” refers to an artificial intelligence programming technique wherein computer programs are encoded as a set of genes that are then modified (evolved) using an evolutionary algorithm. It is an automated method for creating a working computer program from a high-level problem statement. Genetic programming starts from a high-level statement of “what needs to be done” and automatically creates a computer program to solve the problem. The result is a computer program able to perform well in a predefined task.

A “journey” or “user journey” refers to a script, such as for a video game that has a detailed theme. The journey tracks potential positions the user can be in, as defined by an environment, as well as particular avatars that the user may be associating with. The term can be used to describe which parts of the simulated environment give the most accurate simulation and can thereby produce a simulated script. It can also be used to describe a particular sequence of positions that a particular user has taken.

In marketing and business intelligence, “A/B testing” is a term used for randomized experimentation with a control performing against one or more variants.

“WYSIWYG (What You See Is What You Get) Editor” means a user interface that allows the user to view something very similar to the end result while a document is being created. In general, the term WYSIWYG implies the ability to directly manipulate the layout of a document without having to type or remember names of layout commands. In the context of video editing, “WYSIWYG” refers to an interface that provides video editing capabilities, wherein the video can be played back and viewed with the edits. The video editing with playback occurs within an editor mode.

“Heat Map” shall refer to a graphical representation of data where the individual values contained in a matrix are represented as colors. Color-coding is used to represent relative data values.

### Exemplary Process for a Dynamic Application Visualization System

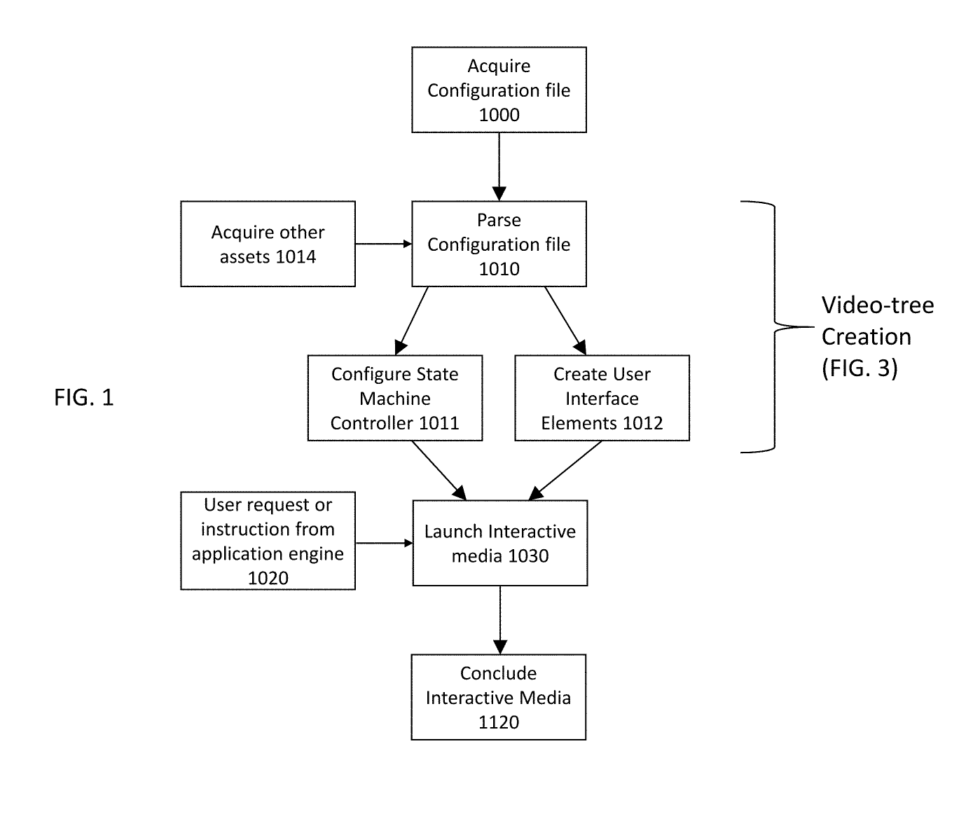

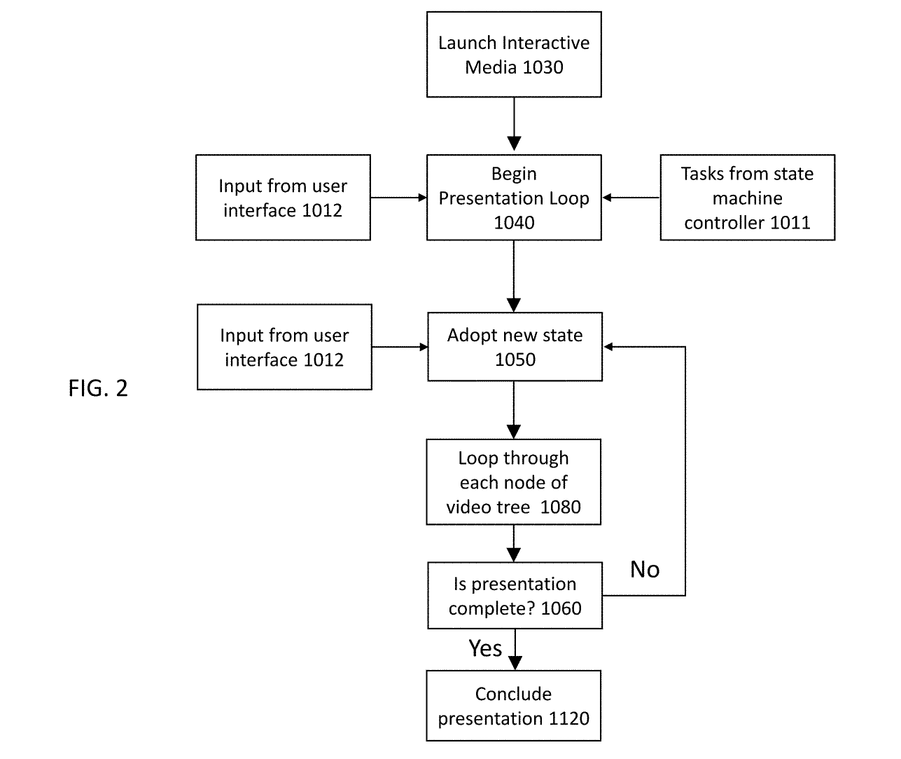

An exemplary process is shown in FIGS. 1 and 2, and is suitable for being executed on a computing apparatus having a memory, processor, input and output devices, as further described herein. FIG. 1 represents an overview of a process for reproducing a segment of interactive media as further described herein. The aim is to create a configuration of an application program that contains instances of all of its essential components, thereby permitting a virtual instance of it to run under control of a user.

The system acquires a configuration file 1000 from a remote server or local source. The configuration file contains definitions of an item of interactive media that is to be reproduced.

The configuration file is parsed 1010 and used as instructions to acquire other video, audio, image or font files (collectively, “assets”) that represent the interactive media.

The configuration file is parsed 1011 and used to configure a state machine controller that involves a method of making a video-tree, as described further herein. The state machine drives the user experience, when reproducing the interactive media in question. The state machine is responsible for handling changes in the presentation of the interactive media, such as prompting audio or video files to begin playback, showing or hiding user interface elements, enabling and disabling touch responsiveness. The user experience can be defined as a set of finite states: a portion are recreated and there are different ways to move between them.

Parsing the configuration file 1012 is also used to create the various operating-system specific user interface elements (video players, image views, labels, touch detection areas, etc.) for display and interaction.

It is understood that the program is typically run within an operating system, or in the case of playable advertising, the interactive media can be run during use of a host application such as a web-browser, or an app on a mobile device.

At some point, the user takes an action that initiates playback of the segment of interactive media 1020. The program may also be driven by an application engine, such as by batch processing, or by utilizing a cloud computing paradigm. The engine includes functionality for creating aspects of the graphical overlay.

The program launches the replicated segment of interactive media 1030 and interacts with the host operating system to present the user interface elements created in 1012, based on the state machine controller 1011.

When the presentation of the various aspects of the segment of interactive media is ended 1120, the program stops, and returns control to the host program.

In some embodiments, as shown in FIG. 2, the program may include a loop 1040 in which the segment of interactive media is presented multiple times in succession or in multiple different ways according to user input. In this way the program is responsible for executing various tasks assigned to it by the state machine controller 1011 dependent on accepting user input from the user interface 1012. In this situation, when the segment of interactive media is launched 1030, instead of being played once, there are multiple events under a user's direction that occur, including possibly the execution of the interactive media more than once. In this way, during playback of the segment of interactive media, the user can explore various user options, according to which the state machine controller responds to the user.

At any time, the state machine controller is able to transition to a new state 1050 based on its configuration. It may do so in response to user input, presentation events such as a video file completing playback, or internally configured events such as timed actions.

Each presentation has a defined end state, usually triggered by a user interaction, such as with a ‘close’ button 1060.

If the presentation is not ended 1070, the presentation loop will allow the state machine to submit its commands to an application engine. On transitioning between states, new video segments may be played, user interface elements may be shown or hidden, touch responsiveness may be activated or deactivated, etc.

The state runtime loop 1080 controls the playback of an individual node on the video tree. This is a self-contained unit that presents one meaningful part of the experience, e.g., in a video baseball game, “batter runs to first after hitting ball”.

A state runtime loop control that controls the playback of each individual node of a video-tree, typically comprises a self-contained “branch” unit that presents a segment of the application experience; a user-interaction experience; a user-interface that captures the user-interaction event, and submits the event to the state machine controller for processing; a state machine controller that interprets the interaction; and an option for the state machine controller to transition to a new state, simulating the user's interaction with the original subject product.

During the state runtime loop, the user may interact with the presentation 1090. If the user performs a valid interaction, the user interface will capture the event and submit it to the state machine controller for processing. The state machine controller changes states based on what user is doing; for example it may interpret a user interaction and choose to transition to a new state, simulating the user's interaction with the original product.

In addition to user interaction events, the state machine controller can have its own configured events 1100. Typically these events are timed, such as displaying a “help” window if the user is inactive for a period of time.

If there is no user interaction and no state machine controller actions to take 1110, the presentation continues—videos and sounds play, etc.—until no more steps can be taken.

Optionally a state machine controller feature may contain independent configured events, comprising: timed events, such as displaying a “help” window if the user is inactive for a period of time, or another anticipated user event; and if there are no user interaction and no state machine controller actions to take, the continuance of the presentation.

Video Sampling into Content Branches

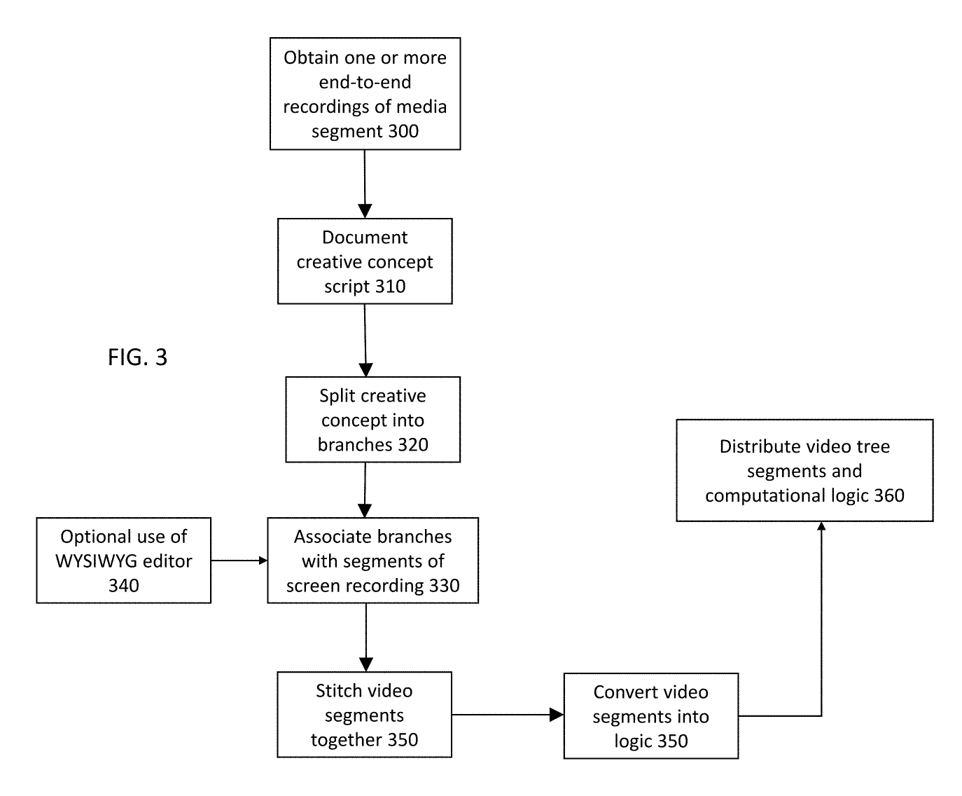

The digital video sampling process that lies behind the steps 1010, 1011, and 1012 of FIG. 1 includes a consumer device screen recording process (such as acquiring the configuration file), creative concept scripting, screen recording footage splitting process, a video tree branching process, computational logic scripting, and distribution. An exemplary process for video-tree creation is as set forth in FIG. 3.

### Obtaining and Storing Application Segments

The digital video sampling process contains a consumer device screen recording process, creative concept scripting, screen recording footage splitting process, a video tree branching process, computational logic scripting, and distribution.

### Screen Recording

The method includes recording 300 in whole or in part of a segment of an interactive media source such as an application program or playable advertisement. The end-to-end recording is operated by a screen recording software, such as QuickTime Player, ActivePresenter, CamStudio, Snagit, Webinaria, Ashampoo Snap, and the like. In some cases, a single end-to-end recording of the desired application sample is all that is required for the remaining processing in order to replicate an application experience. In other cases, multiple recordings may be taken, especially if a tree with a high branching factor is being created. The recording can occur on any consumer computing device such as a desktop computer, mobile handset, or a tablet.

### Creative Concept Scripting

Once the one or more screen recordings are completed, a creative concept is scripted 310 that outlines the application features contained in the screen recording. The creative concept script provides an outline of the user journey captured in the one or more screen recordings.

The creative concept outlines core concepts of the application. For instance, if the application is a game, the concept will outline the game's emphasis, player goals, flow, script and animation sequences. Storyboarding techniques such as those using a digital flow diagram are utilized to organize and identify the application's configuration and user journey.

For example, if a user is playing an application that provides an interactive baseball video-gaming experience on a handheld device, a screen recording is made of the user playing the game from the beginning of one inning to the end of that inning. A creative concept is then created of all of the user's interactions (concept segments), such as:

1. the user selects a baseball team (e.g., the New York Yankees);
2. the application informs the user that they are up to bat;
3. the user selects a bat;
4. the user selects a style of pitch;
5. the user swipes the device screen to engage the player to swing at a pitch.

### Splitting the Screen Recording

Utilizing the user journey recorded in the creative concept script as a guide, the screen recordings are split into a variety of branches 320, referred to herein as a video tree. Each segment of the creative concept represents, and correlates with a piece of the screen recording and is a unique branch of the application video tree. The video is segmented into a plurality of branches to mirror all possible user interactions. Video editing software is used to split the screen recording into micro-segments.

For example, a game is segmented into a variety of micro-segments, some segments as short as 0.6 seconds. A segment can conceivably be as short as 0.03 seconds, so that the recording becomes a short sequence of effectively still images. Each micro-segment is allocated to a portion of the creative concept script. Micro-segments can range in length from 0.01 s to 3 mins., such as 0.1 s to 1 min., or 0.5 s to 30 s, or 1 s to 15 s, where it is understood that any lower of upper endpoint of the foregoing ranges may be matched up with any other lower of upper end point.

### Video-Tree Branching

Each creative concept branch is paired to the video representation (screen recording) 330 of the interactive media that corresponds to that branch. For example, a baseball game can contain hundreds of possible branches, each branch representing a portion of a game played by a user captured in the video recording. Each branch has the possibility of containing a plurality of sub-branches, each sub-branch organized as a possible portion of a user journey that has not yet been travelled, and associated video file.

In one embodiment, an additional program layer is created to automate the production of the video-tree branches. To implement this process, an editor, such as a WYSIWYG editor 340 is used to automate the creation of computational logic. The editor is instructed to download a file containing the storyboard, such as a document containing a flow chart, and programmatically creates the configuration logic for the video-tree. Here, the editor programmatically splits the input video into video-tree branches.

The WYSIWYG editor program is able to analyze the video segments, and distribute the segments into video-tree branches according to the creative concept provided. In this embodiment, the program integrates user-interaction detection, for example, the implementation of a user touch detection component, where each user touch on a screen generates a new branch within the video-tree. This allows the program to quickly generate the video-tree with a high degree of consistency and visual precision.

The various video-tree branches can be stitched together 350 so that they loop autonomously, thereby no longer requiring a developer to manually stitch video segments together using video editing software.

### Computational Logic

In a preferred embodiment, a rules-based system is implemented to execute operation of the state machine controller. Such an approach simplifies the way that the operation is segmented. The rules-based system is used to create the video tree.

Computational logic can be scripted to mirror and perform actions represented in each video tree branch. Logic programming is a programming paradigm based on cognitive logic. A program written in a logic programming language is a set of sentences in logical form, expressing facts and rules about a specified domain. In the context of application reproduction, programmatic logic can be written to process rules of a video game, perform specified parameters of functions based on those rules, and respond to the existence of certain criteria.

There are two underlying processes that work together simultaneously: an internal engine containing programmed and predefined behaviors using computational logic (for example, playing a video segment, playing a sound, playing an interaction), and a downloadable configuration file that defines which behaviors to operate and when to operate them. Because the existing industry standard makes it impossible to download an application engine (containing source code and computational logic) into a consumer device, the technology described herein provides an alternative by pairing a generated application engine with the application configuration file. The generated engine is created using the video-tree branching method described herein, and paired with a downloadable configuration file of the original application.

Each branch of the application's video-tree correlates to an associated configuration logic 350. Likewise, the logic references specific branches of the application video-tree. The resulting logic-based program is able to play back the application and produce an application with the look and feel of the original application because the configuration file of the original application is paired to the generated video-tree engine.

In one preferred embodiment, logic is written as a configuration file containing sections that define different parts of the behavior of the program. The sections include resource controls (videos, sounds, fonts and other images), state controls (execution logic), and interface controls (collecting user input). Each individual element under each controller has an identifier that allows the controllers to coordinate interactions between each other and their elements, and a pre-determined set of action items it can execute. At runtime, the configuration file is parsed by the engine to enable or disable those interactions as a subset of its full functionality thereby creating the simulated experience.

The following is an example portion of code that defines a touch screen “tap” detector:

```
{
    “name”: “toolbox slot 2 tap area”,
    “kAOBViewSerializationKeyId”: 104,
    “kAOBViewSerializationKeyType”:
“kAOBViewSerializationValueTypeGestureRecognitionView”,
    “kAOBViewSerializationKeyRelativeX”: 0.408,
    “kAOBViewSerializationKeyRelativeY”: 0.82308845,
    “kAOBViewSerializationKeyRelativeWidth”: 0.186667,
    “kAOBViewSerializationKeyRelativeHeight”: 0.128935,
    “kAOBViewSerializationKeyInitiallyVisible”: true,
    “kAOBViewSerializationKeyBackgroundColor”: {
      “kAOBViewSerializationKeyRedColorComponent”: 0,
      “kAOBViewSerializationKeyGreenColorComponent”: 0,
      “kAOBViewSerializationKeyBlueColorComponent”: 0,
      “kAOBViewSerializationKeyAlphaColorComponent”: 0
    },
    “kAOBViewSerializationKeyGestures”: [
      {
        “kAOBViewSerializationKeyGestureType”:
“kAOBViewSerializationValueGestureRecognitionTypeTap”,
        “kAOBViewSerializationKeyTapCount”: 1,
                  “kAOBViewSerializationKeyStateTransitions”: [
          {
            “kAOBViewSerializationKeyStateFrom”: 22,
“kAOBViewSerializationKeyStateTransitionPossibilities”: [{
              “kAOBViewSerializationKeyStateTo”: 23,
              “kAOBViewSerializationKeyStateProbability”: 1
            }]
          }
        ]
      }
    ]
  },
```

This script instructs the user interaction engine to create a view with a defined set of features, such as size, color, and position. This view is a tap-detection view, and when the view is active and the user taps on it, the state machine controller will be instructed to transition to state ID #23 if it is in state ID #22. Upon exiting state ID #22 and entering state ID #23, the state machine controller may have further commands that it triggers in the engine to present or hide views, play sounds or movies, increase the user's score, and perform other functions as defined in its controller configuration.

In another embodiment of the logic programming process, the logic is machine generated. A programmatic approach, such as machine learning or a genetic algorithm, is utilized to recognize the existence of certain movements and user functions in the video-tree. The machine learning program identifies interactions occurring in the video-tree segments and matches those segments to the relevant portion of the configuration script. The paired logic is saved with the referenced video-tree segments.

For video-trees with interchangeable component videos, a genetic algorithm approach is typically implemented. Interchangeable “component videos” that make up branches of the video-tree are computationally arranged to create dynamic presentations of the information.

A machine learning approach is an appropriate technique where data-driven logic is created by inputting the results of user play-throughs into a machine learning program. The machine learning program dynamically optimizes the application experience to match what the statistics indicate has been most enjoyable or most successful. This allows the video-tree logic to be more adaptive and customized to individual users at time of execution. This in turn allows for dynamic, real-time application scripting, thereby providing a significant improvement over the current application experience, which is static and pre-scripted to a generic user type.

### Distribution

The completed video and logic files are then made available for download 360 to first parties (the application developer), and third parties (such as advertising agencies, feature testing platforms).

The process of making the completed application experience available comprises: uploading the completed video-tree segments to a content distribution system, importing the computational logic to a database on a server, and providing access to these resources to the third parties.

Any client software integrated with the presentation system can acquire these resources and present the end-user with the application reproduction. The resources themselves remain under private control and as such do not have to go through any third party (such as App Store) review or approval. Importing the computational logic into a database provides the ability to dynamically create variant presentations using server-side logic to customize an experience to a particular user upon request or to otherwise optimize the presentation using previously mentioned machine learning or genetic techniques.

### Aspects of Feature Testing Using Dynamic Graphical Visualizations

An exemplary system comprises a back-end program, front-end user controls, and a suggestion engine.

Back-End Program

The back-end of the system contains: a database with all collected application user interactions; repositories of video content; and one or more behavioral definition files. A custom data integration occurs where the program executes on any combination of data objects from the backend system. This is done in a manner so that a viewer can select specific video segments from the application being tested, play user interactions relating directly to the selected video segment, and operate the behavioral definition files that run the application, thereby linking the video segments to the user interaction data.

Integration of Test Features into the Back-End Program

An application developer can integrate test features to test alongside existing behavioral definition files. This allows the developer to see how the new features can be integrated into the application, and view the integration alongside existing user interactions and behavioral definition files, as a video segment.

Front-End User Controls

The viewer can select from a taxonomy of application segments, such that they have access to all variations of application paths (i.e., video-tree branches). The viewer can replay any video-tree branch (the video-tree method is described elsewhere herein), view metrics by video segment, and view a visual replay of the video segment with a graphical overlay of user-interactions. Metrics include, but are not limited to aspects of running an application such as statistics on user behavior. In particular, the user behavior includes the time spent in the application, what parts of the interface were touched (i.e., tapped or swiped) by users, and whether users were able to accomplish a specific task with the application. The visual replay can aggregate user interactions from the user interaction database and display the user interactions in the form of data visualizations played over video segments, such as, for example, heat maps showing how the population of users commonly interacted with the application. A heat map provides the viewer a graphical representation of user interaction data, wherein a shading, or color-coding, or bar-chart can be used to represent the relative values of user engagement with the application. For instance, in a color-coding form of a heat map, red could represent a high value for user interaction, whereas light blue could represent a lower value. In preferred embodiments, a user is provided with a choice of replays, in the form of a set of configurable replay parameters that correspond to frequently taken paths through the application. For example, amongst the data for the population of users that have run the application at least in part, it is typically the case that there are a small number of well-trodden paths that have been taken by multiple users.

In a further preferred embodiment, a user is also provided with a number of datasets containing use data for the application, which correspond to different use scenarios. For example, given a large number of choices for starting parameters for running the application, the actual choices typically taken will often cluster into a small group of parameters having particular values.

Suggestion Engine

In one embodiment, a suggestion engine is implemented into the back-end program. The suggestion engine is a data analytics feature that provides suggestions on changes to the application that are likely to improve user engagement. The program identifies from the user interaction weaknesses in the application and provides suggested improvements based on learned user behaviors, such as from user behaviors in general (as measured for all users against all programs) for which data is available.

Real-Time User Data (User Data API):

In another embodiment, the application developer can use a real-time application program interface (API) to provide user data to the back-end database, or integrate the data via an API for immediate play via the front-end controls. This allows the developer to see in real-time how users are engaging with an application. The developer an explore the video segments to see which portions of the application are in use, and to what extent the application is being used.

Overview of User Interaction with the System

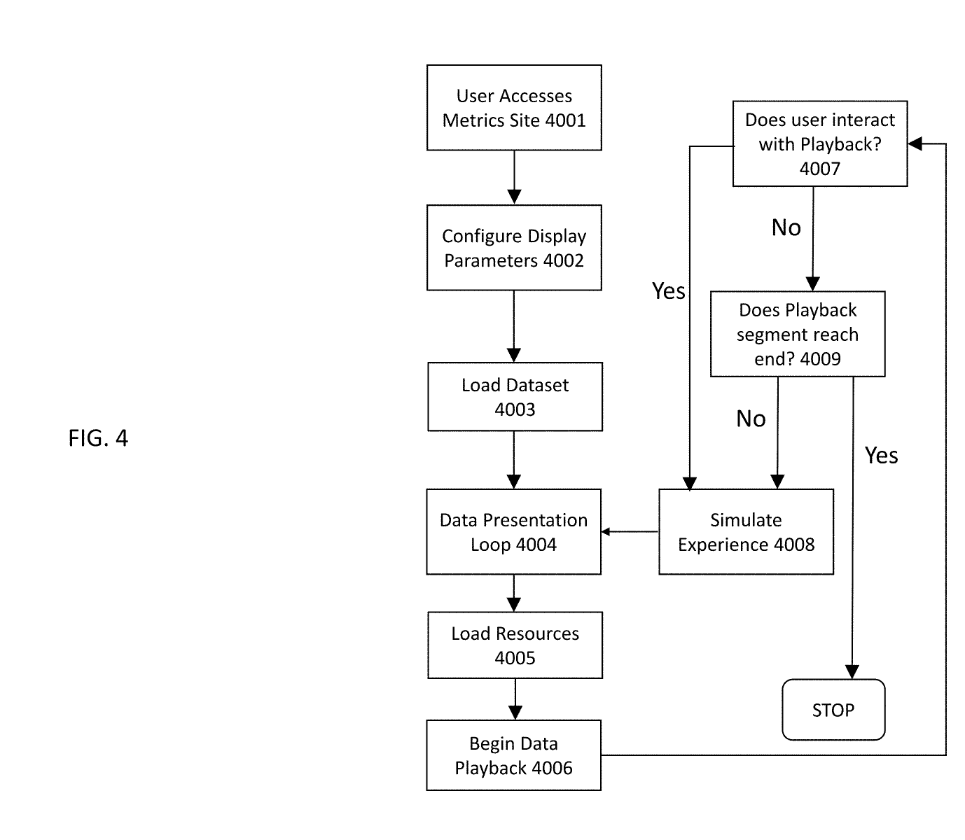

FIG. 4 illustrates steps in a user interaction with an exemplary embodiment of the system.

Authorized clients access 4001 their data on the metrics visualization site, for example by providing appropriate credentials, such as a password or suitable authentication key.

The client interfaces with the metrics visualization site to optionally configure parameters 4002 affecting display playback of runtime application data. The client selects a presentation unit to examine, and instructs the program to apply any desired dataset partitioning or filtering, such as by application, region, or demographic.

The metrics website downloads 4003 the configured dataset from its database server.

The metrics website enters the data presentation sequence 4004, which typically runs as a loop until complete.

Appropriate resources are loaded 4005 for the audio/visual components of the presentation, including movie files, image files, sound files, etc. There is a resource file that automatically pairs the applicable audio/visual components to the selected data presentation sequence.

Data playback is executed 4006. Using the presentation configuration file and the collected datapoints, presentation of user interactions can be shown in synchronization with the user's reconstructed audio/visual experience. A visual heatmap is overlaid in synchronization with the playback, thereby illustrating user interactions as they occurred.

The user can interact with the data presentation playback as if (s)he were an actual user of the application. If (s)he does so, the presentation playback can adjust itself to simulate what users who performed that interaction actually experienced.

The data playback mechanism uses the presentation configuration to simulate the experience 4008 as presented to users in the active dataset. This can include aspects such as, but not limited to, playing videos and sounds, and showing and hiding images. Simulating the experience may include moving to an entirely different playback scene. The data playback mechanism can run in a loop by returning to the top and loading newly required resources and then continue playback.

Each user experience has an end state. If the data presentation sequence reaches a point where all user experiences in its dataset have ended 4009, the presentation ends. Otherwise, the program continues to the simulation step 4008.

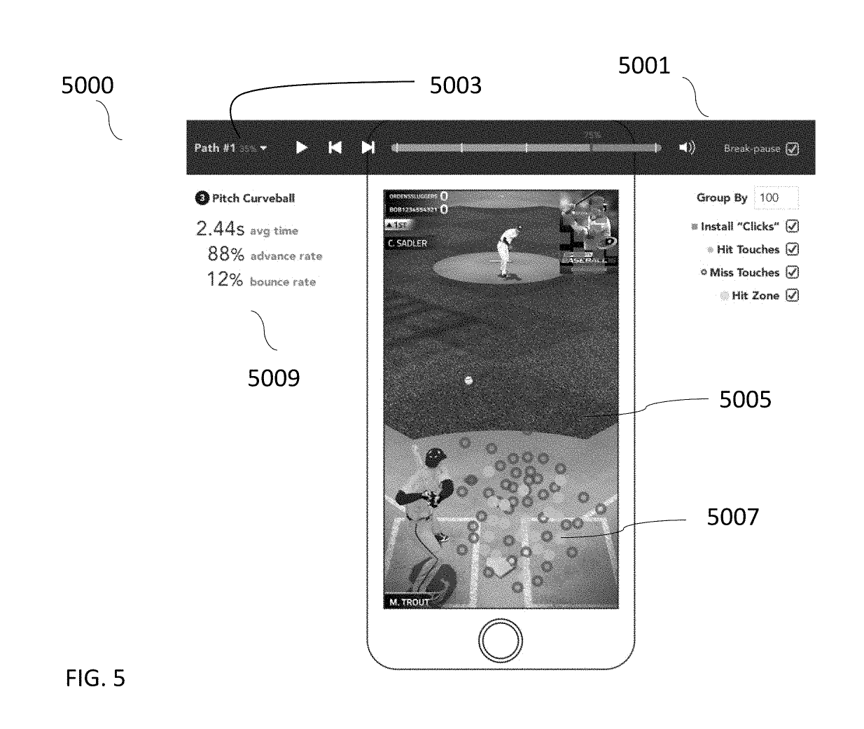

FIG. 5 shows an exemplary web user interface 5000, that displays user metrics of a digital application, in this case a simulated baseball game. The interface incorporates several features. A playback mechanism 5001 is shown at the top of the display to show run-time application data, and contains several controls that permit a user to start, pause, stop, forward or reverse, the progress of a virtual instance of the application program. The mechanism 5001 can also include such features as a volume control, a bar or equivalent way to display the progress (runtime) of the application, and a list of pathways through the application that can be selected by the user. It would be understood that the positioning of mechanism 5001 at the top of the display is arbitrary; mechanism 5001 can be conveniently located at other positions, such as to one side, or at the bottom.

FIG. 5 further illustrates a “heat map” 5005, 5007, which overlays the application. In FIG. 5, heat map 5005 comprises open circles and closed circles 5007 which represent, respectively, areas of interaction in which a user is unsuccessful or successful in accomplishing a particular task in a game. In other embodiments, the heat map may represent points, immediately after which users typically exit the application, or continue to play. It is consistent with this technology that the “heat map” can take other forms, depending on the form of the interface and the application that is being replicated. For example, heat maps may be color coded but do not have to be; they may contain multiple (more than 2) different types of symbol to illustrate more than two aspects of user behavior.

Interface 5001 also shows certain application metrics 5009, such as average time that a user spends in the application or relevant portion of it. The metrics 5009 are shown at one side of the interface but may be displayed at other positions, as desired.

### Feature Testing

The dynamic visualization system allows developers to create a hypothetical environment to feature test, and edit an application.

To date, application developers have been unable to rapidly launch and test new application features due to restrictions on application stores such as Google Play and the iOS App Store. The ability to quickly test new themes, colors, gaming accessories, player options, and the like before releasing the features to the public is inhibited by reproduction limits, and other operational hurdles. The video-tree reproduction method described herein overcomes such feature testing hurdles. Entities may now sample and reproduce portions of an application and insert new features in a dynamic, real-time environment.

The feature testing presentation is solely video based. In this respect, pure video and video editing techniques are used to create parts of the application, and even, if desired, the entire application. Developing and integrating a feature into a game can take considerable effort in terms of 3D modeling, texturing, engine import, asset placement, scripting, state persistence, etc. The game or application will then have to be recompiled, possibly resubmitted to a distributor (such as an app store), and finally authorized by the end user for installation on their device. The video-tree technology described herein, allows for application presentations that are both lightweight to create (any video is ingested as content) and present (there are no requirements for a distributor intermediary, or end-user authorization). When the user is running an application that has integration with the video-tree technology described herein, the system platform is able to keep all application presentations in the most up-to-date condition, including downloading new or replacement resources as the original application changes.

### Live Editing of Application Features Based on User Preferences

Understanding a user's application preferences requires real-time analysis of the user's interactions with the application. Doing so in a public test environment is largely impossible due to the difficulty of reproducing accurate application samples. Furthermore, integrating new features quickly is limited by the operational aspects of connecting with users via application stores. Live editing of application features based on user preferences is enabled by the technology described herein, by creating a sample environment in which the developer can view and implement changes to the game based on a variety of learned user preferences.

In one embodiment, the system can integrate market data from a third party which provides information about the user, such as their age, gender, location, and language. The system has a library of user characteristics paired with a variety of player preferences, such that, for example, an avatar in a game will change genders, age and language based on who the user of the application is.

### Live Data Collection and Storage of User Interaction Data Correlated to the Application Segment (Unit)

Granular data of application user interactions can be used to optimize an application. Understanding, in aggregate and in detail, how users interface with an application can be helpful in making improvements to the application. Doing so within the environment of an application video-tree, allows for ease of access to the exact points at which a user performs a specific interaction. Granular analysis within the video-tree segments provides the developer with an organized, exploratory environment in which they can view how the user interacted, how they reacted to the interaction, and whether there were any negative responses to the interaction such as the user leaving the game, or stalling to move forward in the game. The underlying method allows developers, for the first time, the ability to replay the data against the user segments without having to record actual video of the user playing.

The user data and the computational logic interact with the video-tree segments to provide accurate replay. Because the system is built with a deterministic configuration for the presentation and recording of all user interaction and engine state change information, the system is able to precisely replay the user's experience including all video and audio by running the state machine controller with the recorded user interaction as input. The architecture allows for a “record once, replay many” construction that allows the developer to recreate many user experiences without requiring those users to individually transmit recorded video.

### Creation of a Data Array of Touch Events

Many modern day applications involve the user physically interfacing with the application by applying a number of different types of touch motion to a flat-screen consumer device. These motions include swiping the screen with a finger, holding the finger down on a screen, tapping the screen, splaying two fingers to alter the zoom of a view, and combinations thereof. These finger-to-screen motions represent a wide range of possible actions occurring in the application environment, such as simulating the hitting of a ball in a baseball game, or the capturing of imaginary creatures. Unclear instructions on how to engage with the touch screen can often result in negative user reactions to an application. Likewise, many developers attempt to make the interaction as intuitive as possible. The ability to clearly analyze what touch mechanisms are successful versus those that are not requires the developer to collect and analyze that data.

The system described herein collects touch data as a data array. The array is created from touch events, including touch parameters that define the nature of the touch. These parameters can include data on, for example, how long the user touched the screen, the direction of a swipe on the screen, how many fingers were used, and the location on the screen of the touch. The touch data array is then mapped to the video-tree segments, and related application logic. The touch data array can be replayed as video to show how the user touched the screen and what motions the touch produced based on the deployed application logic.

Playback with Analytics and Data Visualizations

Playback of real-user interactions can be enhanced with data, such as the number of users engaged in a specific interaction with the application. Visualizations can also be generated to show the likelihood of certain interactions based on data of past user behavior, such as the likelihood of certain touch interactions. In one example, a heat map is utilized to show the likelihood of a user swiping a certain direction on a flat screen when reaching a specific point in the video-tree. The playback and analytics can be filtered for specified criteria so that playback can be produced to represent a specific user type, such as men of a specific age range living in a specific region.

### Automated A/B Testing for Performance Evaluation

In the application testing industry, use of A/B testing means that an application developer will randomly allow some users to access the control version of the application, and other users will access variants of the application. Doing so today is complicated by the fact that deploying variants of an application is challenging due to application reproduction costs, as well as the application store approval process (described in greater detail above). With the technology described herein, it is possible to apply a novel approach to A/B testing. This novel approach involves the collection of a plurality of user data, and automating the playing of the artificial user data against variants of video-trees.

In one embodiment, the application developer provides a hypothesis of how players might respond to the proposed application variant. The system automatically produces data of how users actually interact with the application variants. New artificial user data is generated and compared with the control application user data. This allows the developer to analyze how new application features will play out without having to make the new features available to the public via an application store. It allows for the efficient, robust and thorough exploration of a wide variation of features, and the production of new user-interaction data, which ultimately results in an optimized application evaluation process.

### Computational Implementation

The computer functions for carrying out the methods herein can be developed by a programmer, or a team of programmers, skilled in the art. The functions can be implemented in a number and variety of programming languages, including, in some cases mixed implementations. Various programming languages may be used for portions of the implementation, such as C, C++, Java, Python, VisualBasic, Perl, .Net languages such as C#, and other equivalent languages not listed herein. The capability of the technology is not limited by or dependent on the underlying programming language used for implementation or control of access to the basic functions. Alternatively, the functionality could be implemented from higher level functions such as tool-kits that rely on previously developed functions for manipulating video streams.

The technology herein can be developed to run with any of the well-known computer operating systems in use today, as well as others, not listed herein. Those operating systems include, but are not limited to: Windows (including variants such as Windows XP, Windows95, Windows2000, Windows Vista, Windows 7, and Windows 8, Windows Mobile, and Windows 10, and intermediate updates thereof, available from Microsoft Corporation); Apple iOS (including variants such as iOS3, iOS4, and iOS5, iOS6, iOS7, iOS8, and iOS9, and intervening updates to the same); Apple Mac operating systems such as OS9, OS 10.x (including variants known as “Leopard”, “Snow Leopard”, “Mountain Lion”, and “Lion”; the UNIX operating system (e.g., Berkeley Standard version); the Linux operating system (e.g., available from numerous distributors of free or “open source” software); and the Android OS for mobile phones.

To the extent that a given implementation relies on other software components, already implemented, those functions can be assumed to be accessible to a programmer of skill in the art.

Furthermore, it is to be understood that the executable instructions that cause a suitably-programmed computer to execute the methods described herein, can be stored and delivered in any suitable computer-readable format. This can include, but is not limited to, a portable readable drive, such as a large capacity “hard-drive”, or a “pen-drive”, such as connects to a computer's USB port, an internal drive to a computer, and a CD-Rom or an optical disk. It is further to be understood that while the executable instructions can be stored on a portable computer-readable medium and delivered in such tangible form to a purchaser or user, the executable instructions can also be downloaded from a remote location to the user's computer, such as via an Internet connection which itself may rely in part on a wireless technology such as WiFi. Such an aspect of the technology does not imply that the executable instructions take the form of a signal or other non-tangible embodiment. The executable instructions may also be executed as part of a “virtual machine” implementation.

The technology herein is not limited to a particular web browser version or type; it can be envisaged that the technology can be practiced with one or more of: Safari, Internet Explorer, Edge, FireFox, Chrome, or Opera, and any version thereof.

The computational methods described herein can be supplied as a code library or software development kit, suitable for use by a developer or other user that wishes to embed the methods inside another application program such as a mobile application. As such the methods can be implemented to interact with a host operating system and accept input from a user interface.

A further instance can include a machine controller to direct an application engine (a program that contains logic to drive interactive presentation, such as for loading resources, handling user interaction, and presenting media, until an exit condition is reached). The machine controller is able to transition to between states based on its configuration. In each state, the controller submits commands to the engine to produce the presentation. The machine controller can comprise code for carrying out dynamic transitions based on user input, presentation events such as video file playback, or internally configured events such as timed actions. Each presentation contains a defined end state, such as triggered by a user interaction with a “close” button; and a presentation loop that, if not ended, allows the state machine to submit commands to the engine, such as replay of a video, hiding or showing user interface elements, and activating or deactivating touch responsiveness.

### Computing Apparatus

The methods herein can be carried out on a general-purpose computing apparatus that comprises at least one data processing unit (CPU), a memory, which will typically include both high speed random access memory as well as non-volatile memory (such as one or more magnetic disk drives), a user interface, one more disks, and at least one network or other communication interface connection for communicating with other computers over a network, including the Internet, as well as other devices, such as via a high speed networking cable, or a wireless connection. There may optionally be a firewall between the computer and the Internet. At least the CPU, memory, user interface, disk and network interface, communicate with one another via at least one communication bus.

Computer memory stores procedures and data, typically including some or all of: an operating system for providing basic system services; one or more application programs, such as a parser routine, and a compiler, a file system, one or more databases if desired, and optionally a floating point coprocessor where necessary for carrying out high level mathematical operations. The methods of the technologies described herein may also draw upon functions contained in one or more dynamically linked libraries, stored either in memory, or on disk.

Computer memory is encoded with instructions for receiving input from one or more users and for replicating application programs for playback. Instructions further include programmed instructions for implementing one or more of video tree representations, internal state machine and running a presentation. In some embodiments, the various aspects are not carried out on a single computer but are performed on a different computer and, e.g., transferred via a network interface from one computer to another.

Various implementations of the technology herein can be contemplated, particularly as performed on computing apparatuses of varying complexity, including, without limitation, workstations, PC's, laptops, notebooks, tablets, netbooks, and other mobile computing devices, including cell-phones, mobile phones, wearable devices, and personal digital assistants. The computing devices can have suitably configured processors, including, without limitation, graphics processors, vector processors, and math coprocessors, for running software that carries out the methods herein. In addition, certain computing functions are typically distributed across more than one computer so that, for example, one computer accepts input and instructions, and a second or additional computers receive the instructions via a network connection and carry out the processing at a remote location, and optionally communicate results or output back to the first computer.

Control of the computing apparatuses can be via a user interface, which may comprise a display, mouse, keyboard, and/or other items, such as a track-pad, track-ball, touch-screen, stylus, speech-recognition, gesture-recognition technology, or other input such as based on a user's eye-movement, or any subcombination or combination of inputs thereof. Additionally, implementations are configured that permit a replicator of an application program to access a computer remotely, over a network connection, and to view the replicated program via an interface.

In one embodiment, the computing apparatus can be configured to restrict user access, such as by scanning a QR-code, requiring gesture recognition, biometric data input, or password input.

The manner of operation of the technology, when reduced to an embodiment as one or more software modules, functions, or subroutines, can be in a batch-mode—as on a stored database of application source code, processed in batches, or by interaction with a user who inputs specific instructions for a single application program.

The results of application simulation, as created by the technology herein, can be displayed in tangible form, such as on one or more computer displays, such as a monitor, laptop display, or the screen of a tablet, notebook, netbook, or cellular phone. The results can further be printed to paper form, stored as electronic files in a format for saving on a computer-readable medium or for transferring or sharing between computers, or projected onto a screen of an auditorium such as during a presentation.

All references cited herein are incorporated by reference in their entireties.

The foregoing description is intended to illustrate various aspects of the instant technology. It is not intended that the examples presented herein limit the scope of the appended claims. The invention now being fully described, it will be apparent to one of ordinary skill in the art that many changes and modifications can be made thereto without departing from the spirit or scope of the appended claims.

1. A method for graphic display of metrics for an application, the method comprising:
providing a user with a set of configurable replay parameters for the application;
providing the user with a plurality of datasets containing use data for the application, from which to choose;
upon instruction from the user to run the application program with the set of replay parameters and a selected dataset:
displaying run-time application data on a user-interface;
presenting a playback of a reproduction of the application with one or more graphical overlays corresponding to and representing the user-selected dataset, wherein the graphical overlays illustrate human-application interactions as they occurred.

2. The method of claim 1, wherein the playback of the reproduction of the application comprises two or more segments that are executed in sequence.

3. The method of claim 2, wherein, if a playback segment has not yet ended, a user may choose to interact with the playback in a simulation as if the user were an original application user.

4. A method for application reproduction, simulation, and playback, the method comprising:
downloading a configuration file from a remote server or local source;
parsing the downloaded configuration file;
using the parsed configuration file to instruct on acquiring one or more video, audio, image and font files;
sampling each of one or more video files and splitting each file into content branches;
deriving a creative concept script for each of the video files;
splitting the creative concept script into a number of branches;
pairing each of the branches with the video files;
configuring an internal state machine for one or more features of application user experience;
creating user interface elements for display and interaction, wherein the interface elements include one or more overlays that illustrate behavior of a population of users of the application.

5. A computer readable medium, encoded with instructions for:
graphic display of metrics for an application, according to claim 4; and
configured for execution under control of an operating system on a host computing device.
